(19) United States
(12) Patent Application Publication
(10) Pub. No.: US 2007/0245361 A1
(43) Pub. Date: Oct. 18, 2007

(54) Flat Cable Device For Optical Pickup Heads

(76) Inventors: Chien-Kuo Chen, Keelung City (TW); Tsung-Kai Chang, Hsinchu Hsien (TW); Chin-Sung Liu, Hsinchu (TW); Li-Chung Peng, Hsinchu (TW)

Correspondence Address: Lin & Associates Intellectual Property, Inc., P.O. Box 2339, Saratoga, CA, 95070-0339, US

(21) Appl. No.: 11/379,221

(22) Filed: Apr. 18, 2006

(51) Int. Cl. G11B 33/12

(52) U.S. Cl. 720/652

(57) ABSTRACT

A flat cable device for an optical pickup head is provided, including a traverse mechanism having a disc loader and an optical pickup unit, and a flexible printed circuit or a flat cable. The disc loader is for holding a disc, and the optical pickup unit is for reading and writing data to the disc. One end of the flat cable is connected to the optical pickup unit, and the other is connected to a circuit board. By changing the placement direction and the extending out location of the flat cable and connection with the optical pickup head, the problem of interference between the flat cable and the traverse mechanism is avoided and the traverse mechanism is enhanced.

### FIELD OF THE INVENTION

The present invention generally relates to an optical compact disc (CD) and DVD device, and more specifically to the placement of the flat cable of an optical pickup head of the device.

### BACKGROUND OF THE INVENTION

The rapid progress in technology has not only made many electronic devices smaller and lighter in weight, but also more trendy and design-oriented to meet the consumer demands.

The electronic devices cover a wide range of applications, including the recent audiovisual products, such as players for movies and music CDs. This type of players is designed for working with computers or in vehicles. To accommodate the working environment of smaller room, the compact disc players are getting thinner and thinner.

As the thinness required for the contemporary compact disc player, the internal mechanisms inside the compact disc player is an important design issue. To achieve the slim or the semi-slim design, the internal design of a compact disc play must be enhanced to maintain the stability and the endurance.

The design of the traverse of the conventional compact disc player imposes restrictions on the design of the slim or semi-slim compact disc players. FIG. 1 shows a schematic view of a conventional flexible printed circuit (FPC) and the traverse of a compact disc player. The traverse of a compact disc player includes a traverse mechanism 10, a flexible printed circuit 12, an optical pickup unit 14, and a disc loader 15.

Disc loader 15 is placed on top of traverse mechanism 10 for loading and holding a compact disc 17, indicated by the dash lines. Optical pickup unit 14 is on bearing 16 on both sides of traverse mechanism 10 for reading from or writing to disc 17. Optical pickup unit 14 is also connected through FPC to circuit board (not shown) for transmitting data and commands. Pickup fixture end 121 of FPC 12 is engaged to optical pickup unit 14, and circuit board connection end 122 is connected to the connection end of the circuit board (not shown). Optical pickup unit 14 moves between disc loader 15 and mechanism corner 11 by the movement of bearing 16 to read or write.

Refer to FIGS. 2 and 3. FIG. 2 is a top view of the conventional location of FPC and the mechanism interference. FIG. 3 is an enlarged front view of the conventional optical pickup unit and the FPC. When optical pickup unit 14 is near to inner track 172 of the disc for reading or writing, no interference between optical pickup unit 14 and the FPC arises. However, when optical pickup unit 14 is near outer track 171 of the disc for reading or writing, the interference problem occurs due to the design of the connected FPC 12.

The shortcoming of design is because that optical pickup unit 14 is connected to FPC 12, which is bended and goes under optical pickup unit 14. Therefore, FPC 12 forms a bending angle (R) 23. R angle 23 interferes with mechanism corner 11 when optical pickup unit 14 is on outer track 171 of the disc. To protect R angle 23 and the FPC, the conventional design sacrifices the width of mechanism corner 11 in order to make enough space to accommodate R angle 23.

In other words, to avoid the collision between R angle 23 and mechanism corner 11, mechanism corner 11 is designed to be narrow and thin, which may lead to fragility of mechanism corner 11 and the difficulty of space usage. In addition, to avoid the friction between FPC 12 and disc 17 when optical pickup unit 14 moves, the connector on the circuit board (not shown) can only be placed near to inner track 172 of the disc. Therefore, circuit board connection end 122 can only be connected near to the inner track.

### SUMMARY OF THE INVENTION

The present invention has been made to overcome the above-mentioned drawback of conventional design of the flat cable of an optical pickup head. The primary object of the present invention is to provide an enhanced traverse mechanism for a slim or semi-slim compact disc player to maintain the operational stability.

Another object of the present invention is to provide a design in which the circuit board connection end of the flat cable and the connector of the circuit board are not restricted to be connected near the inner track of the disc.

The conventional optical pickup unit only uses FPC to connect the circuit board. The present invention can use both FPC and flat cable to connect the optical pickup unit and the circuit board. The flat cable used in the present invention is less expensive; therefore, the present invention can reduce the manufacture cost.

The present invention changes the location where the flat cable and the optical pickup unit are connected to avoid the collision of the FPC and the mechanism corner of the conventional design. By changing the direction of the flat cable, the mechanism corner is enhanced to enable the design of even thinner traverse for the compact disc players.

The connection of the flat cable and the optical pickup unit is to place the flat cable directly above and in parallel with the signal connection end of the optical pickup unit and is soldered together. Therefore, the connection location of the flat cable and the circuit board can be changed as the design of the circuit board, instead of being restricted to be near the disc loader as in conventional design. The placement direction of flat cable enables the future design of traverse of compact disc players for more possibilities.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a top view of a conventional flexible printed circuit (FPC) and traverse of a compact disc player;

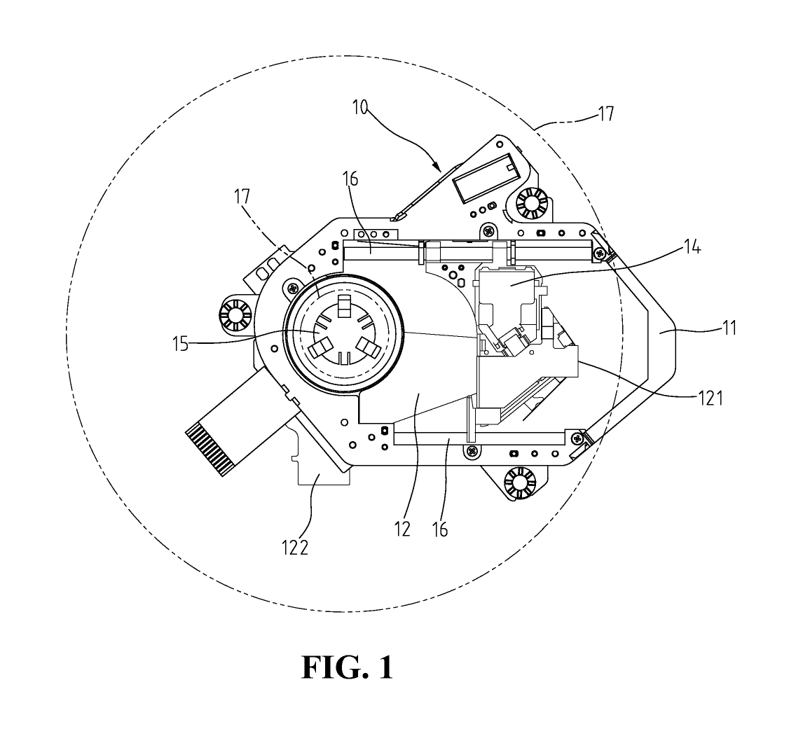

FIG. 2 shows a top view of the interference between the location of a FPC and a traverse mechanism;

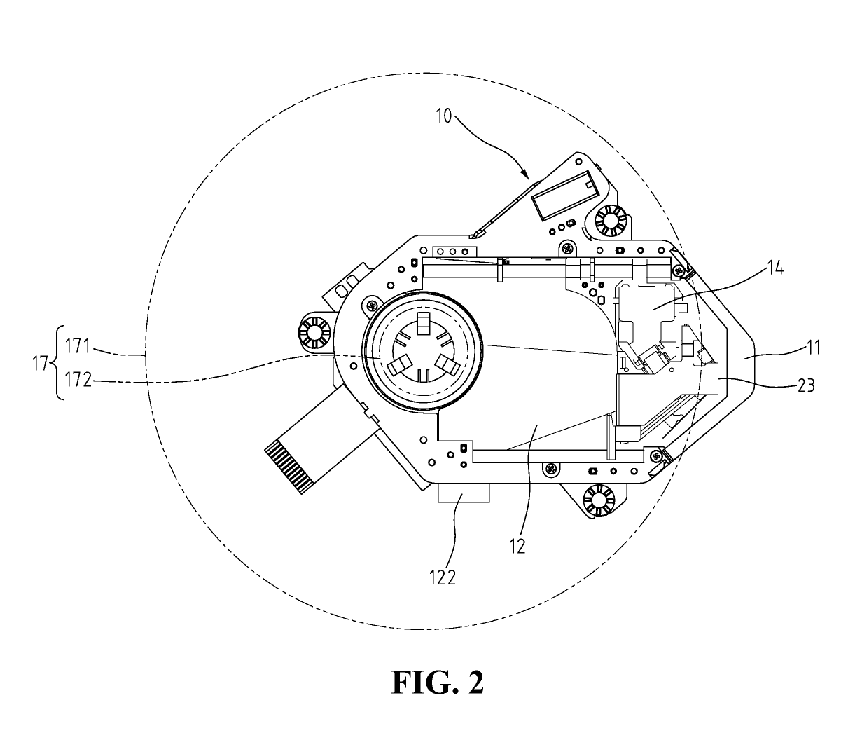

FIG. 3 shows an enlarged front view of an optical pickup unit and a FPC of a conventional compact disc player;

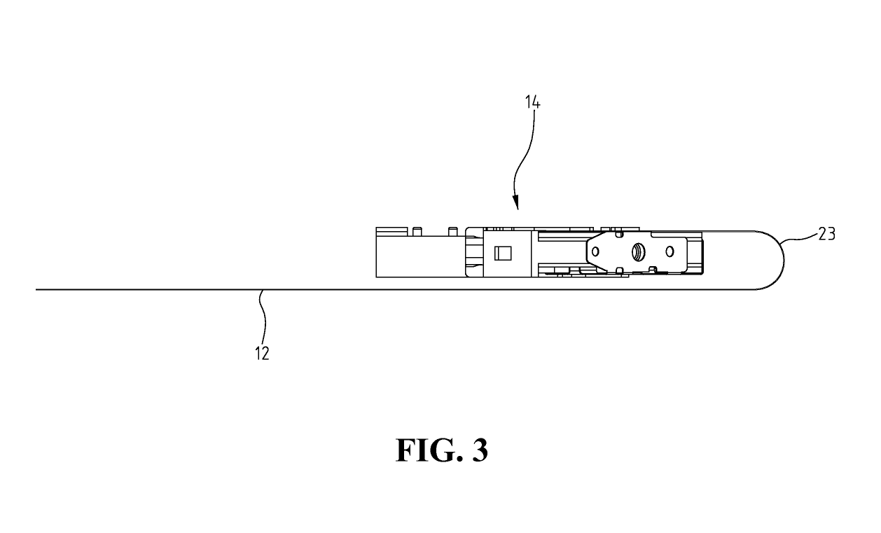

FIG. 4 shows a top view of the flat cable placement direction and the traverse mechanism of the present invention;

FIG. 5 shows an enlarged front to of the flat cable and the optical pickup head of the present invention;

FIG. 6 shows an enlarged view of the optical pickup head before the installation of the flat cable according to the present invention; and

FIG. 7 shows an enlarged view of the optical pickup unit and the flat cable after being soldered together.

### DETAILED DESCRIPTION OF THE PREFERRED EMBODIMENTS

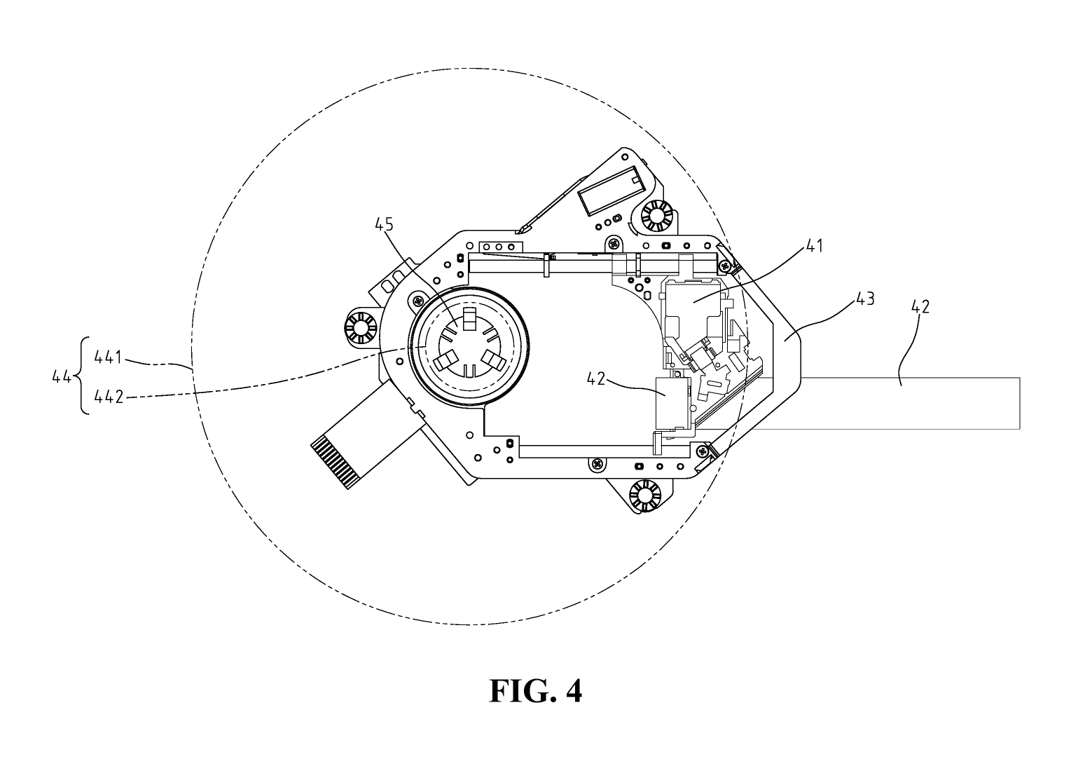

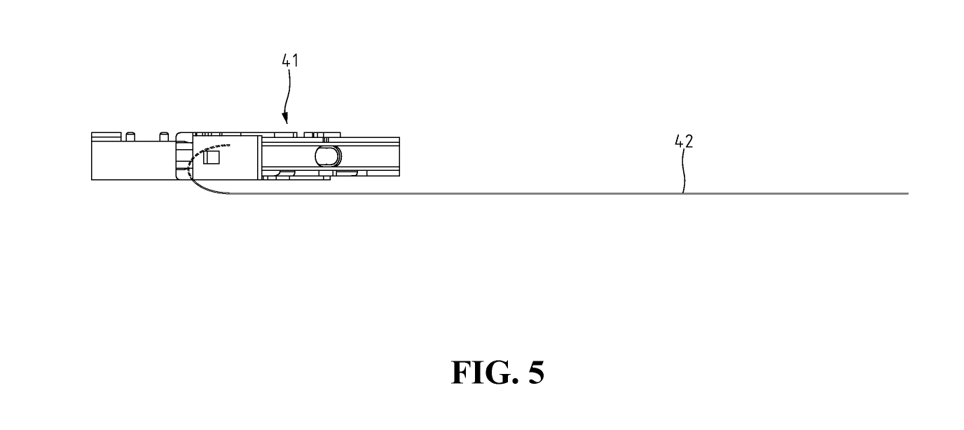

Refer to FIGS. 4 and 5. FIG. 4 shows a top view of the flat cable placement direction and the traverse mechanism of the present invention. FIG. 5 shows an enlarged front to of the flat cable and the optical pickup head of the present invention. The traverse includes a disc loader 45 for holding a disc 44, and an optical pickup unit 41 movable between inner track 441 of disc 44 and outer track 442 of disc 44 for reading or writing data to disc 44. Flat cable 42 is connected to the upper part of optical pickup unit 41 and is bended downwards to pass underneath optical pickup unit 41 and mechanism corner 43. Therefore, there is no flat cable 42 or flexible printed circuit between optical pickup unit 41 and mechanism corner 43, and hence, there will no interference.

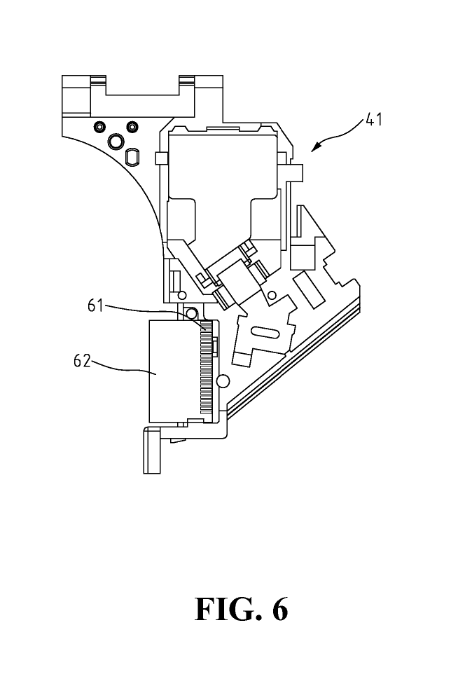

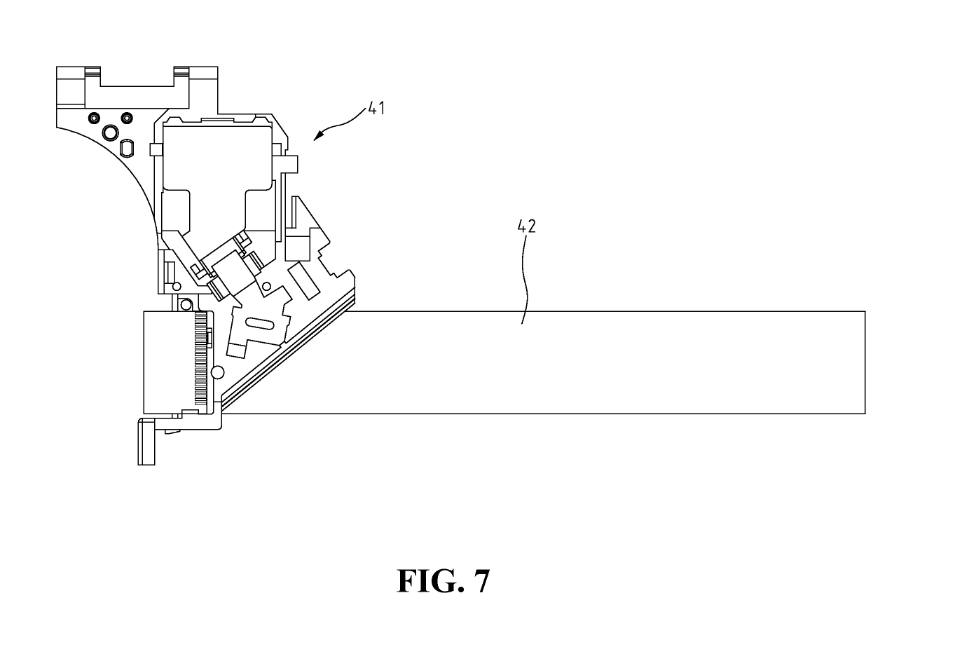

Refer to FIGS. 6 and 7 for a clear view of the flat cable of the present invention. FIG. 6 shows an enlarged view of the optical pickup head before the installation of the flat cable according to the present invention. FIG. 7 shows an enlarged view of the optical pickup unit and the flat cable after being soldered together. Optical pickup unit 41 is connected to the flat cable short segment 62, which includes a signal connection end 61. A longer flat cable 42 is placed above and aligned with signal connection end 61. Flat cable 42 and signal connection end 61 are soldered together, and are bended to go underneath optical pickup unit 41, as shown in FIG. 5.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A flat cable device for optical pickup heads, comprising:
a traverse mechanism, having a disc loader for holding a disc and an optical pickup unit for reading and writing data to said disc; and
a flat cable, connected to said optical pickup unit and a circuit board.

2. The flat cable device as claimed in claim 1, wherein said optical pickup unit has a short segment flat cable with a signal connection end.

3. The flat cable device as claimed in claim 2, wherein said flat cable is placed above and aligned to, and is soldered to said signal connection end of said short segment flat cable.

4. The flat cable device as claimed in claim 1, wherein the extending out location of said flat cable is between said disc loader and said optical pickup unit.
